(19) United States
(12) Patent Application Publication
(10) Pub. No.: US 2026/0313081 A1
(43) Pub. Date: Oct. 8, 2026

(54) CONTROL METHOD FOR PROJECTION APPARATUS, PROJECTION SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventors: Yutaro IIJIMA, Matsumoto-shi (JP); Tetsuo MANO, Shiojiri-shi (JP)

(73) Assignee: SEIKO EPSON CORPORATION, Tokyo (JP)

(21) Appl. No.: 19/638,578

(22) Filed: Apr. 3, 2026

(30) Foreign Application Priority Data
Apr. 4, 2025 (JP) 2025-062756

(51) Int. Cl. H04N 9/31

(52) U.S. Cl. CPC H04N 9/3194; H04N 9/3129; H04N 9/317; H04N 9/3185

(57) ABSTRACT

A control method for a projection apparatus includes, by one or more processors, acquiring a first distance from a projection lens to a first position on a target and a second distance from the projection lens to a second position on the target based on output from a first sensor, acquiring a gravity vector in a first three-dimensional coordinate system based on output from a second sensor, specifying first coordinates of the first position in the first three-dimensional coordinate system based on the first distance, specifying second coordinates of the second position in the first three-dimensional coordinate system based on the second distance, and specifying a first normal vector of a plane related to the target in the first three-dimensional coordinate system based on the first coordinates, the second coordinates, and the gravity vector.

The present application is based on, and claims priority from JP Application Serial Number 2025-062756, filed Apr. 4, 2025, the disclosure of which is hereby incorporated by reference herein in its entirety.

### BACKGROUND

### 1. Technical Field

The present disclosure relates to a projection apparatus control method, a projection system, and a non-transitory computer-readable storage medium storing a program.

### 2. Related Art

A technique of projecting an image on a target such as a screen by a projection apparatus is known. Furthermore, a technique of correcting an image according to a positional relationship between a target and a projection apparatus after specifying the positional relationship is known. The positional relationship is determined based on, for example, the normal vector of the target. WO 2022/193560 describes an example of such a technique.

WO 2022/193560 is an example of the related art.

However, in the related art, there is a problem that it may be difficult to appropriately specify the normal vector of the target.

In the method in the related art of specifying the normal vector of an approximate plane, it is necessary to acquire three-dimensional coordinates of three or more target feature points. The method described in WO 2022/193560 also requires three or more target feature points. However, three-dimensional coordinates of three or more target feature points may not be able to be acquired. Alternatively, even when three-dimensional coordinates of three or more target feature points can be acquired, the accuracy of the coordinates may be low. In these cases, it is difficult to appropriately specify the normal vector of the target.

### SUMMARY

An example of a control method for a projection apparatus according to the present disclosure is a control method for a projection apparatus that projects an image onto a target via a projection lens, including by one or more processors, acquiring a first distance from the projection lens to a first position on the target and a second distance from the projection lens to a second position on the target based on output from a first sensor, acquiring a gravity vector in a first three-dimensional coordinate system based on output from a second sensor, specifying first coordinates of the first position in the first three-dimensional coordinate system based on the first distance, specifying second coordinates of the second position in the first three-dimensional coordinate system based on the second distance, and specifying a first normal vector of a plane related to the target in the first three-dimensional coordinate system based on the first coordinates, the second coordinates, and the gravity vector.

An example of a projection system according to the present disclosure is a projection system that projects an image onto a target via a projection lens, including acquiring a first distance from the projection lens to a first position on the target and a second distance from the projection lens to a second position on the target based on output from a first sensor, acquiring a gravity vector in a first three-dimensional coordinate system based on output from a second sensor, specifying first coordinates of the first position in the first three-dimensional coordinate system based on the first distance, specifying second coordinates of the second position in the first three-dimensional coordinate system based on the second distance, and specifying a first normal vector of a plane related to the target in the first three-dimensional coordinate system based on the first coordinates, the second coordinates, and the gravity vector.

An example of a non-transitory computer-readable storage medium storing a program according to the present disclosure for controlling a projection apparatus that projects an image onto a target via a projection lens, the program causes one or more processors to execute acquiring a first distance from the projection lens to a first position on the target and a second distance from the projection lens to a second position on the target based on output from a first sensor, acquiring a gravity vector in a first three-dimensional coordinate system based on output from a second sensor, specifying first coordinates of the first position in the first three-dimensional coordinate system based on the first distance, specifying second coordinates of the second position in the first three-dimensional coordinate system based on the second distance, and specifying a first normal vector of a plane related to the target in the first three-dimensional coordinate system based on the first coordinates, the second coordinates, and the gravity vector.

### BRIEF DESCRIPTION OF THE DRAWINGS

FIG. 1 shows a usage example of a projection apparatus 10 according to Embodiment 1.

FIG. 2 shows a configuration example of the projection apparatus 10.

FIG. 3 shows a configuration example of a projector 11 in FIG. 2.

FIG. 4 is a flowchart showing an operation example of the projection apparatus 10 in FIG. 1.

FIG. 5 shows the details of step S1 in FIG. 4.

FIG. 6 shows the details of step S5 in FIG. 4.

FIG. 7 shows a configuration example of a distance sensor 14 according to Embodiment 2.

FIG. 8 is a flowchart showing a processing example of step S1 according to Embodiment 2.

FIG. 9 shows a usage example of a projection apparatus 10 according to Embodiment 3.

FIG. 10 is a flowchart showing a processing example of step S1 according to Embodiment 3.

FIG. 11 shows an example of a captured image.

FIG. 12 is a flowchart showing an operation example of a projection apparatus 10 according to Embodiment 4.

FIG. 13 shows the details of step S31 in FIG. 12.

FIG. 14 shows the details of step S35 in FIG. 12.

FIG. 15 shows an example of processing in step S36 in FIG. 12.

FIG. 16 is a flowchart showing a processing example of step S31 in Embodiment 5.

### DESCRIPTION OF EMBODIMENTS

Hereinafter, embodiments of the present disclosure will be described with reference to the accompanying drawings.

### Embodiment 1

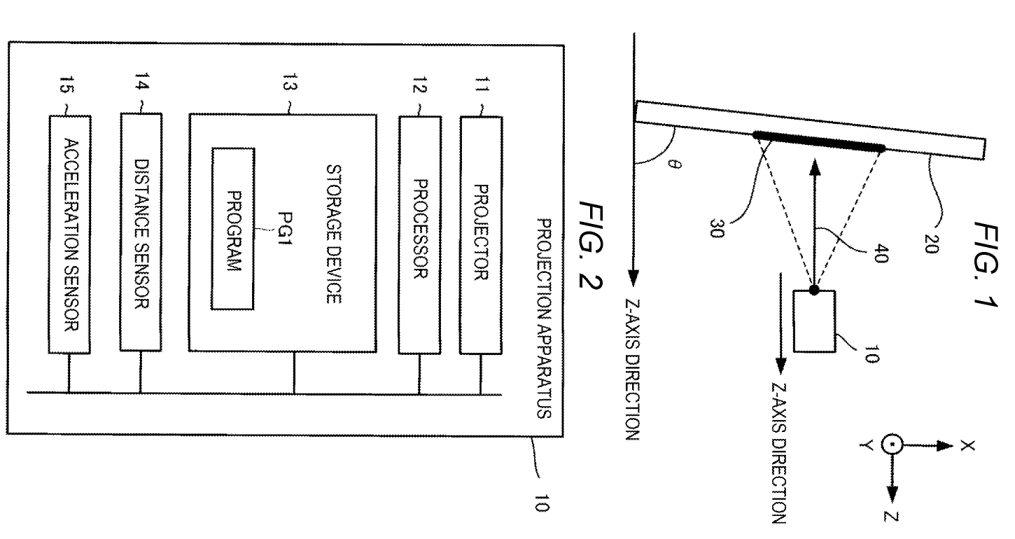

FIG. 1 shows a usage example of a projection apparatus 10 according to Embodiment 1. The projection apparatus 10 projects a projection image 30 as an image on a screen 20. FIG. 1 illustrates coordinate axes of a three-dimensional coordinate system. The three-dimensional coordinate system is expressed using three axes of an X axis, a Y axis, and a Z axis. The X axis, the Y axis, and the Z axis are orthogonal to one another. In FIG. 1, the paper surface is parallel to the XZ plane. In FIG. 1, the Z axis is parallel to an optical axis 40 of the projection apparatus 10.

The projection apparatus 10 projects an image onto a target. In the present embodiment, the screen 20 is used as an example of the target. The screen 20 has a planar surface. Preferably, the entire one surface of the screen 20 forms a substantially single plane. Alternatively, the screen 20 has a shape that can be approximated as a plane by using an approximate plane. In this case, the approximate plane can be the planar surface of the screen 20.

The screen 20 is installed parallel to the direction of gravity. That is, the planar surface of the screen 20 is installed parallel to the direction of gravity. In FIG. 1, the Y axis and the direction of gravity are parallel to each other, but the Y axis and the direction of gravity may not be parallel to each other. This will be described later in relation to the definition of the coordinate system.

As a modification, the target may not be a screen. The target may include a plurality of planar surfaces. The target may include a curved surface. The target may not include a planar surface, that is, may include only a curved surface.

In FIG. 1, the projection image 30 is projected on the screen 20. Since the screen 20 is disposed parallel to the Y axis as described above, the projection image 30 is represented as a straight line in FIG. 1.

The screen 20 is ideally disposed to be orthogonal to the Z axis. However, in practice, as shown in FIG. 1, the screen is disposed to be not orthogonal to the Z axis in some cases. In the example of FIG. 1, an angle θ between the screen 20 and the Z axis is smaller than 90 degrees.

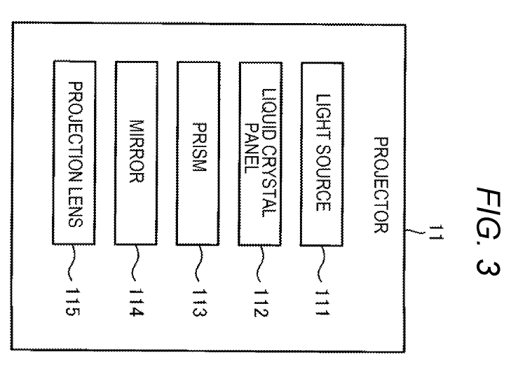

FIG. 2 shows a configuration example of the projection apparatus 10. The projection apparatus 10 includes a projector 11, a processor 12, a storage device 13, a distance sensor 14, and an acceleration sensor 15. The distance sensor 14 is a first sensor. The acceleration sensor 15 is a second sensor.

FIG. 3 shows a configuration example of the projector 11. The projector 11 includes a light source 111, a liquid crystal panel 112, a prism 113, a mirror 114, and a projection lens 115. The light source 111 emits a light for projecting the projection image 30. The liquid crystal panel 112 is an example of a light modulation device. The liquid crystal panel 112 modulates the light emitted from the light source 111. The prism 113 and the mirror 114 control the optical path of the light emitted from the light source 111. The projection lens 115 refracts the modulated light to form the projection image 30. The optical axis of the projection lens 115 is the optical axis 40 shown in FIG. 1.

As described above, the projection apparatus 10 projects the projection image 30 onto the screen 20 via the projection lens 115.

Reference is made to FIG. 2 again. The processor 12 functions as a calculator. The processor 12 can be manufactured using an integrated circuit, an ASIC, an FPGA, or the like. The processor 12 controls the operation of the entire projection apparatus 10. In FIG. 2, only one processor 12 is shown. However, the projection apparatus 10 may include a plurality of the processors 12.

The storage device 13 stores information. The storage device 13 includes a storage medium such as a semiconductor memory device or a magnetic disk device. A part or all of the storage medium may be a non-transitory storage medium. The storage device 13 stores a program PG1.

The processor 12 operates by reading and executing the program PG1 from the storage device 13. The program PG1 is a program for controlling the projection apparatus 10. For example, the processor 12 controls the projection apparatus 10 by executing the program PG1. That is, the program PG1 causes the processor 12 to control the projection apparatus 10.

The distance sensor 14 is a sensor for measuring a distance. The distance sensor 14 can measure distances to at least two points on a target. As the distance sensor 14, for example, a known distance sensor can be used. For example, a sensor using light such as a ToF (Time Of Flight) sensor may be used. Alternatively, a sensor using ultrasonic waves may be used.

The acceleration sensor 15 is a sensor for measuring an acceleration. The output of the acceleration sensor 15 includes information by which the direction of the acceleration can be specified. For example, the acceleration sensor 15 measures accelerations with respect to three orthogonal axes. That is, the acceleration sensor 15 outputs an acceleration vector. Here, for example, when the projection apparatus 10 is stationary, the acceleration sensor 15 outputs a gravity vector. The gravity vector is a vector indicating the direction and magnitude of gravity.

Further, the projection apparatus 10 may include a communication device (not illustrated). The communication device may include a network interface. The communication device may perform wired communication. The communication device may perform wireless communication.

The projector 11, the distance sensor 14, and the acceleration sensor 15 are respectively calibrated with respect to one common three-dimensional coordinate system. The one common three-dimensional coordinate system is a first three-dimensional coordinate system.

For example, the processor 12 can specify a region where the projection image 30 is projected by the projector 11 in the space in the first three-dimensional coordinate system. For example, when the projection image 30 is rectangular, a quadrangular pyramid can be specified in the first three-dimensional coordinate system. For example, the processor 12 can specify the coordinates of a point in the first three-dimensional coordinate system based on the output from the distance sensor 14 corresponding to the point in the space. For example, the processor 12 can specify the direction of gravity in the first three-dimensional coordinate system based on the output from the acceleration sensor 15. Alternatively, the processor 12 can specify the gravity vector in the first three-dimensional coordinate system based on the output from the acceleration sensor 15.

In the present embodiment, the first three-dimensional coordinate system is defined as a three-dimensional coordinate system that satisfies both of the following conditions (1) and (2).
(1) The origin of the first three-dimensional coordinate system is the position of the principal point of the projection lens 115 of the projection apparatus 10.
(2) The Z axis of the first three-dimensional coordinate system is parallel to the optical axis 40 of the projection lens 115 of the projection apparatus 10.

The Y axis of the first three-dimensional coordinate system can be set in any orientation within a plane orthogonal to the Z axis. In general, it is preferable that the Y axis positive direction and the upward direction when the projection apparatus 10 is normally installed coincide with each other because a human can easily grasp the coordinate system.

By using such a coordinate system, calculation of coordinates is simplified. For example, when the coordinates of each point at which the projection image 30 is projected on the screen 20 are calculated, the amount of calculation is reduced. However, the above coordinate system is an example. The first three-dimensional coordinate system can be optionally defined. For example, even in a coordinate system in which a position other than the position of the principal point of the projection lens 115 of the projection apparatus 10 is the origin, it is possible to calibrate the projector 11, the distance sensor 14, and the acceleration sensor 15 in accordance with the coordinate system. Similarly, even in a coordinate system in which the Z axis is not parallel to the optical axis 40 of the projection lens 115, the projector 11, the distance sensor 14, and the acceleration sensor 15 can be calibrated in accordance with the coordinate system.

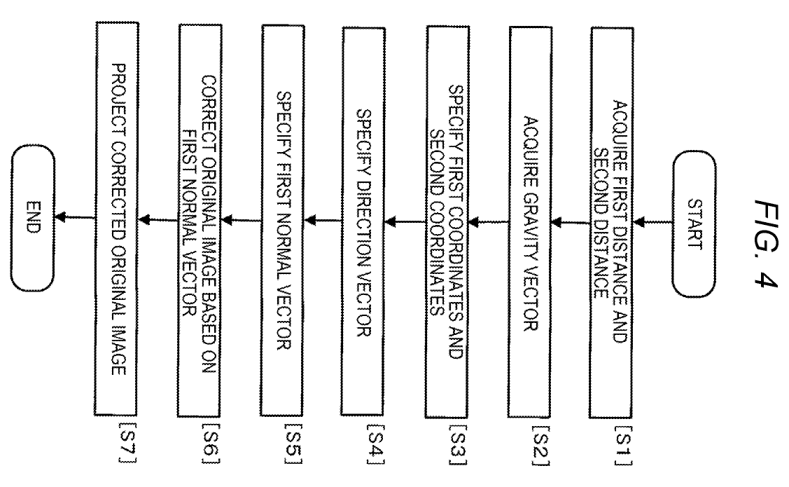

FIG. 4 is a flowchart showing an operation example of the projection apparatus 10 according to the present embodiment. This flowchart illustrates a control method for the projection apparatus 10. The control method for the projection apparatus 10 is executed by the processor 12. The processor 12 may execute this control method by executing the program PG1. That is, the program PG1 may be a program that causes the processor 12 to execute the control method for the projection apparatus 10.

In the present embodiment, the control method is executed by the single processor 12. However, in a modification, the control method may be executed by a plurality of the processors 12.

The processing in FIG. 4 is started, for example, in response to a user of the projection apparatus 10 performing an operation for causing the projection apparatus 10 to specify the orientation of the screen 20. When the processing in FIG. 4 is started, in step S1, the processor 12 acquires a first distance and a second distance based on the output from the distance sensor 14.

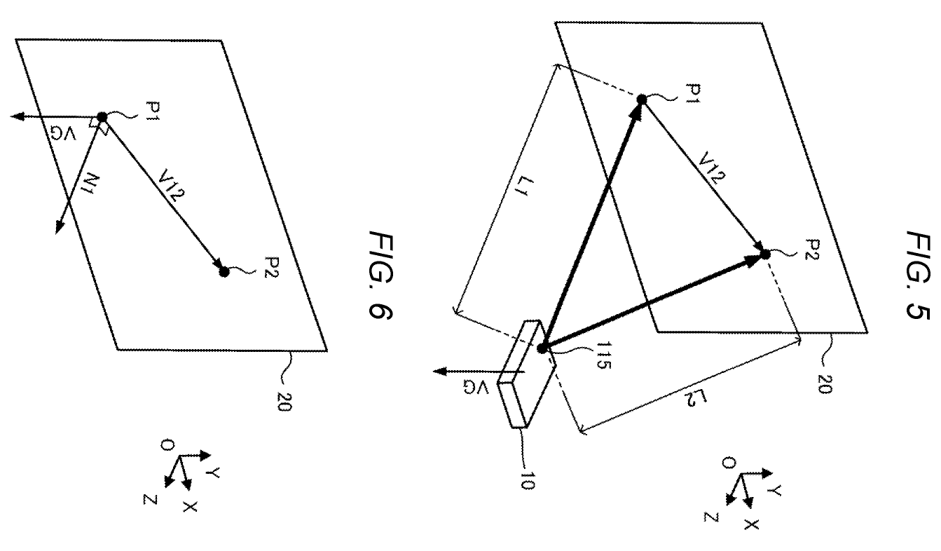

The details of step S1 will be described with reference to FIG. 5. The first distance L1 is a distance from the projection lens 115 to a point P1 on the screen 20. The point P1 indicates a first position. The position of the projection lens 115 is indicated by, for example, the position of the principal point of the projection lens 115. The second distance L2 is a distance from the projection lens 115 to a point P2 on the screen 20. The point P2 indicates a second position. The first position and the second position are different from each other.

Then, in step S2, the processor 12 acquires a gravity vector VG in the first three-dimensional coordinate system based on the output from the acceleration sensor 15.

Then, in step S3, the processor 12 specifies first coordinates and second coordinates based on the first distance L1 and the second distance L2. The first coordinates are coordinates of the point P1 in the first three-dimensional coordinate system. The second coordinates are coordinates of the point P2 in the first three-dimensional coordinate system.

Then, in step S4, the processor 12 specifies a direction vector V12 having the coordinates of the point P1 and the coordinates of the point P2 at both ends. In the example of FIG. 5, the point P1 is the initial point of the direction vector V12, and the point P2 is the terminal point of the direction vector V12. The initial point and the terminal point of the direction vector V12 may be switched.

Then, in step S5, the processor 12 specifies a first normal vector based on the direction vector V12 and the gravity vector VG.

The details of step S5 will be described with reference to FIG. 6. The first normal vector N1 is a normal vector of the screen 20 in the first three-dimensional coordinate system. Since the screen 20 is installed parallel to the direction of gravity as described above, the first normal vector N1 can be specified as a vector orthogonal to both the direction vector V12 and the gravity vector VG. For example, the first normal vector N1 is calculated as an outer product of the direction vector V12 and the gravity vector VG.

More strictly, the "normal vector of the screen 20" can be expressed as a normal vector of a plane related to the screen 20, including a case where the screen 20 contains a plurality of planes and a case where the screen 20 contains a curved surface. The first normal vector N1 is a normal vector of a plane related to the screen 20. Here, the plane related to the screen 20 is a plane containing the point P1 and the point P2 and parallel to the gravity vector VG.

Here, the direction vector V12 is specified based on the coordinates of the point P1 and the coordinates of the point P2 in step S4. Therefore, in step S5, the first normal vector N1 is specified based on the coordinates of the point P1, the coordinates of the point P2, and the gravity vector VG.

As described above, in the present embodiment, the first normal vector N1 is calculated using the direction vector V12. According to the calculation method, the amount of calculation by the processor 12 is reduced. For example, the first normal vector N1 can be calculated using only subtraction of coordinates when the direction vector V12 is calculated and multiplication between vector elements when the first normal vector N1 is calculated. However, as a modification, it is also possible to specify the first normal vector N1 without using the direction vector V12. For example, a method of first specifying a straight line parallel to the gravity vector VG through the point P1, then specifying a plane containing the straight line and the point P2, and finally specifying a normal vector of the plane is also possible.

In the above-described manner, the first normal vector N1 of the plane related to the screen 20 is specified. The processor 12 controls the projection apparatus 10 based on the specified first normal vector N1.

As an example of the control of the projection apparatus 10 based on the first normal vector N1, steps S6 and S7 can be executed. In step S6, the processor 12 corrects the original image based on the first normal vector N1. The so-called keystone correction is performed as an example of the correction. This will be described below.

As shown in FIG. 1, it is assumed that the planar surface of the screen 20 is not orthogonal to the Z-axis direction. In this case, the optical axis 40 of the projection apparatus 10 is not parallel to the first normal vector N1. Therefore, when the original image formed inside the projection apparatus 10 is rectangular, the projection image 30 projected on the screen 20 is quadrangular other than rectangular. In consideration of that, in order to make the projection image 30 rectangular, it is necessary to convert the original image which is originally a rectangle into another appropriate quadrangle. The correction for the conversion may be referred to as keystone correction.

The specific processing of the keystone correction can be appropriately designed by those skilled in the art based on a known technique or the like. An example will be described below. The keystone correction is achieved, for example, by converting the two-dimensional coordinates of each pixel of the original image according to a specific conversion formula. The specific conversion formula can be appropriately designed by those skilled in the art. For example, first, each vertex of a projection quadrangle obtained by projecting an original rectangle forming an original image on a plane parallel to the planar surface of the screen 20 starting from the principal point of the projection lens is calculated. Then, a conversion formula from the coordinates of each vertex of the projection quadrangle in the two-dimensional coordinate system of the plane containing the projection quadrangle to the coordinates of each vertex of the original rectangle in the two-dimensional coordinate system of the plane containing the original rectangle is specified. This conversion formula is a formula for converting the two-dimensional coordinates of each vertex of the projection quadrangle into the two-dimensional coordinates of each vertex of the original rectangle. By converting the two-dimensional coordinates of each pixel of the original image in accordance with the conversion formula, the projection image 30 can be made rectangular.

In this way, the original image is corrected. Then, in step S7, the processor 12 projects the corrected original image via the projection lens 115. Thus, the projection image 30 is projected on the screen 20 via the projection lens 115.

As described above, according to the control method for the projection apparatus 10 according to the present embodiment, it is possible to more easily appropriately specify the first normal vector N1 of the screen 20 by using the gravity vector VG.

For example, in the present embodiment, it is sufficient to acquire the coordinates of two points of the point P1 and the point P2 as the coordinates of the points on the screen 20. Since it is not necessary to acquire the coordinates of three or more points, the processing becomes easier.

In the related art using three or more points, three points that are not particularly on the same straight line are often required. In such a case, since a distance sensor capable of measuring a distance not on a line but on a plane is required, the cost increases. In the present embodiment, since it is sufficient to acquire coordinates of only two points, it is possible to use a distance sensor capable of measuring a distance not on a plane but on a line. Therefore, the cost may be reduced.

Furthermore, when a large number of coordinates are used in the related art, it is not necessarily possible to acquire all the coordinates with high accuracy. According to the present control method, the first normal vector N1 can be identified with high accuracy as long as at least two highly accurate coordinates can be acquired.

The control of the projection apparatus 10 based on the first normal vector N1 is not limited to the control shown in steps S6 and S7. For example, the projection apparatus 10 may output the value of the first normal vector N1. In addition, for example, the projection apparatus 10 may output information prompting the user to adjust the orientation of the screen 20 such that the direction of the first normal vector N1 becomes an appropriate orientation. For example, the projection apparatus 10 may output a warning when the direction of the first normal vector N1 is outside the acceptable range.

### Embodiment 2

Embodiment 2 is an embodiment in which the configuration of the distance sensor 14 is further specified in the first embodiment. Embodiment 2 will hereinafter be described. The description of the parts common to the Embodiment 1 may be omitted.

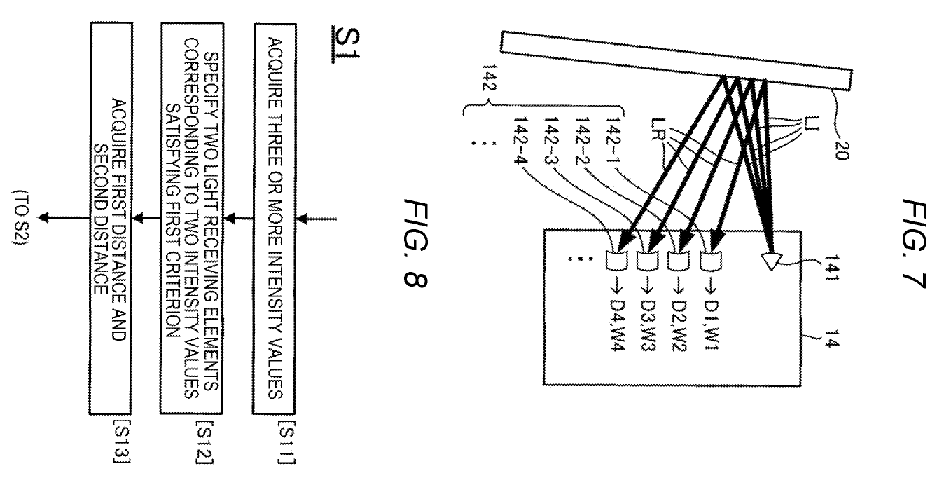

FIG. 7 shows a configuration example of the distance sensor 14 according to Embodiment 2. The distance sensor 14 includes at least one light source 141 and three or more light receiving elements 142. In FIG. 7, a light receiving element 142-1, a light receiving element 142-2, a light receiving element 142-3, and a light receiving element 142-4 are illustrated as examples of the light receiving elements 142. Although the four light receiving elements are shown in FIG. 7, three or more light receiving elements may be provided in the present embodiment as described above.

The light source 141 emits an incident light LI incident on the screen 20. Each of the light receiving elements 142 receives a reflected light LR of the incident light LI reflected from a specific position corresponding to the light receiving element 142 on the screen 20. In other words, the three or more light receiving elements 142 respectively receive the reflected lights LR of the incident light LI reflected from three or more positions on the screen 20.

Each light receiving element 142 outputs a distance and an intensity value. For example, the light receiving element 142-1 outputs a distance D1 and an intensity value W1. The light receiving element 142-2 outputs a distance D2 and an intensity value W2. The light receiving element 142-3 outputs a distance D3 and an intensity value W3. The light receiving element 142-4 outputs a distance D4 and an intensity value W4.

FIG. 8 is a flowchart showing a processing example of step S1 according to the present embodiment. In the present embodiment, step S1 includes steps S11 to S13 shown in FIG. 8.

In step S1, first, in step S11, the processor 12 acquires three or more intensity values W1, W2, W3, W4, …. Here, the processor 12 acquires these intensity values based on the output from the respective three or more light receiving elements 142. These intensity values W1, W2, W3, W4, … are values indicating the intensity of the reflected lights LR. The intensity values W1, W2, W3, W4, … correspond to the three or more light receiving elements 142-1, 142-2, 142-3, 142-4, …, respectively, on a one-to-one basis.

Then, in step S12, the processor 12 specifies two light receiving elements corresponding to two intensity values that satisfy a first criterion among the three or more intensity values W1, W2, W3, W4, …. The first criterion can be optionally defined as a criterion for selecting a light receiving element suitable for use in distance measurement.

For example, the first criterion is that the intensity value is equal to or larger than a threshold defined in advance. Alternatively, for example, the first criterion is that the intensity value is the first or second largest among all the intensity values.

Hereinafter, the two light receiving elements specified in step S12 are referred to as a first light receiving element and a second light receiving element. Then, in step S13, the processor 12 acquires a first distance L1 and a second distance L2. The first distance L1 is a distance acquired based on the output from the first light receiving element. The second distance L2 is a distance acquired based on the output from the second light receiving element.

The processing after step S13 may be executed in the same manner as step S2 and subsequent steps in Embodiment 1.

According to Embodiment 2 described above, the two light receiving elements exhibiting particularly large intensity values are selected from among the three or more light receiving elements 142-1, 142-2, 142-3, 142-4, …. Here, it is considered that when the intensity value of a certain light receiving element is larger, the distance measurement accuracy by the light receiving element is higher. Accordingly, it is possible to suppress reduction in the measurement accuracy of the first distance L1 and the second distance L2. Consequently, it is possible to suppress reduction in the accuracy of the direction vector V12.

### Embodiment 3

Embodiment 3 is an embodiment in which the method of acquiring the distance is changed in Embodiment 1 or 2. Embodiment 3 will hereinafter be described. The description of parts common to Embodiment 1 or 2 may be omitted.

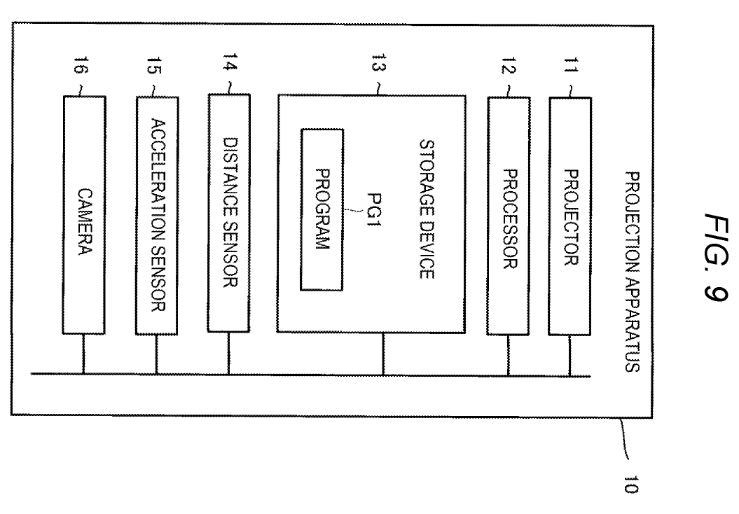

FIG. 9 shows a usage example of a projection apparatus 10 according to Embodiment 3. The projection apparatus 10 includes a camera 16. The camera 16 is an imaging device that captures an image. The camera 16 is a third sensor. The camera 16 is disposed at a position where the screen 20 can be imaged as an imaging target. Alternatively, the camera 16 is disposed at a position where a region of the screen 20, in which the projection image 30 may be projected, can be imaged as an imaging target. The camera 16 includes three or more imaging pixels. Preferably, the camera 16 includes a large number of imaging pixels arranged in a grid pattern.

The camera 16 is calibrated with respect to the first three-dimensional coordinate system. For example, the processor 12 can specify coordinates in the first three-dimensional coordinate system for each pixel of the captured image captured by the camera 16. Alternatively, for example, the processor 12 can specify a straight line in the first three-dimensional coordinate system for each pixel of the captured image captured by the camera 16.

In the present embodiment, similarly to Embodiment 2, the distance sensor 14 includes at least one light source 141 and three or more light receiving elements 142. Each light receiving element 142 outputs a distance. Unlike Embodiment 2, each light receiving element 142 does not need to output the intensity.

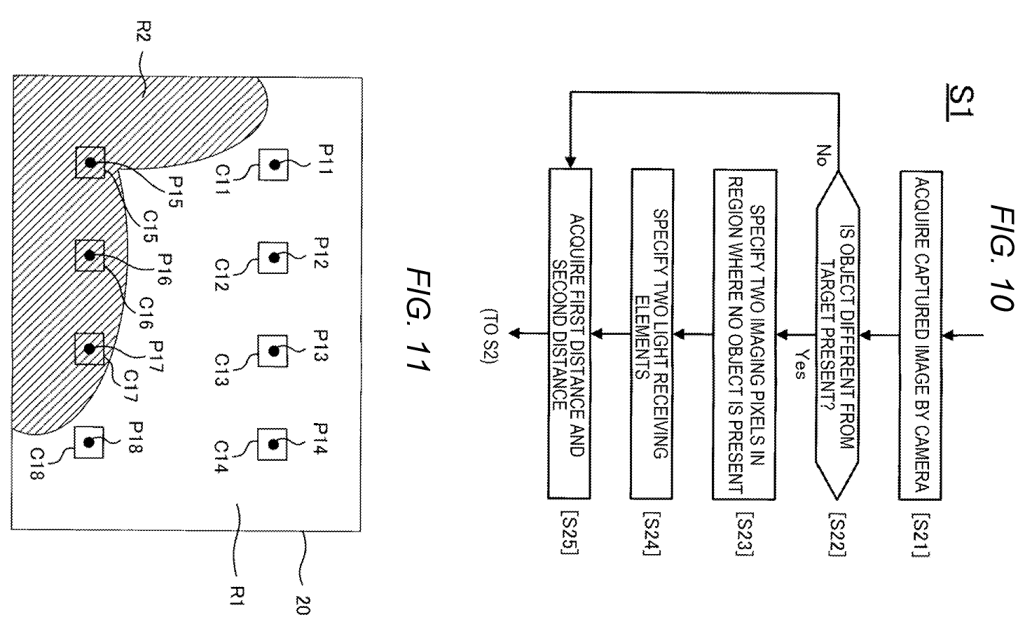

FIG. 10 is a flowchart showing a processing example of step S1 according to Embodiment 3. In the present embodiment, step S1 includes steps S21 to S25 shown in FIG. 10.

In step S1, first, in step S21, the processor 12 acquires a captured image captured by the camera 16. The captured image may be, for example, an image obtained by imaging the screen 20. Alternatively, the captured image may be an image obtained by imaging a region of the screen 20 where the projection image 30 may be projected.

Then, in step S22, the processor 12 determines whether an object different from the screen 20 is present in the space from the projection lens 115 to the screen 20 based on the captured image. Hereinafter, an object different from the screen 20 is simply referred to as an "object".

FIG. 11 shows an example of a captured image. An example of the processing in step S22 will be described with reference to the example of FIG. 11. In the example of FIG. 11, it is determined that an object is present. That is, in the captured image, a region corresponding to the screen 20 includes a first region R1 in which no object is present and a second region R2 in which an object is present. In the example of FIG. 11, the second region R2 is indicated by hatching.

Here, the specific criteria and the details of processing for determining whether an object is present can be appropriately designed by those skilled in the art based on known techniques and the like. For example, the determination may be made based on the color of the pixel. For example, when there is a pixel whose brightness is less than a specific threshold, it may be determined that an object is present at the position of the pixel. Alternatively, for example, edge detection may be performed in the captured image. When an edge is detected in the region corresponding to the inside of the screen 20, it may be determined that an object is present in the darker region of the two regions with the edge in between.

In the example of FIG. 11, the distance sensor 14 includes eight light receiving elements. Points P11 to P18 are shown as points corresponding to the eight light receiving elements. In addition, among the imaging pixels of the camera 16, imaging pixels C11 to C18 are illustrated as imaging pixels corresponding to the eight light receiving elements.

Here, in the example of FIG. 11, the points P11 to P18 and the imaging pixels C11 to C18 correspond on a one-to-one basis. However, in a modification, the points P11 to P18 and the imaging pixels C11 to C18 do not correspond on a one-to-one basis. For example, the point P11 may correspond to two imaging pixels. Alternatively, for example, the point P11 and the point P12 may correspond to the same imaging pixel.

When it is determined in step S22 that an object is present, the processor 12 executes steps S23 and S24. In step S23, the processor 12 specifies two imaging pixels from among the plurality of imaging pixels contained in the first region R1 in which no object is present. In the example of FIG. 11, two imaging pixels are specified from among the five imaging pixels C11, C12, C13, C14, and C18 contained in the first region R1. Here, the criterion for specifying two imaging pixels when three or more imaging pixels are contained in the first region R1 as illustrated in FIG. 11 can be optionally designed. The two imaging pixels specified in step S23 are referred to as a first imaging pixel and a second imaging pixel.

After step S23, in step S24, the processor 12 specifies the two light receiving elements. In particular, the processor 12 specifies the two light receiving elements based on the correspondence relationship between the three or more imaging pixels of the camera 16 and the three or more light receiving elements. For example, the first light receiving element corresponding to the first imaging pixel and the second light receiving element corresponding to the second imaging pixel are specified.

After step S24, in step S25, the processor 12 acquires the first distance L1 and the second distance L2. The first distance L1 is a distance acquired based on the output from the first light receiving element. The second distance L2 is a distance acquired based on the output from the second light receiving element.

When it is determined in step S22 described above that no object is present, the processor 12 advances the processing to step S25. In this case, the first distance L1 and the second distance L2 can be acquired based on output from any two light receiving elements.

The processing after step S25 may be executed in the same manner as step S2 and subsequent steps in Embodiment 1.

According to Embodiment 3 described above, distances in the region where no object is present can be used as the first distance L1 and the second distance L2. Accordingly, since the distances to the screen 20 are measured more accurately, it is possible to suppress reduction in the accuracy of the direction vector V12. In particular, even when the light receiving element 142 does not output information indicating the reliability of the distance measurement result, it is possible to suppress reduction in the accuracy of the direction vector V12.

### Embodiment 4

Embodiment 4 is an embodiment in which the method of specifying a plurality of normal vectors is changed from that in any one of Embodiments 1 to 3. Embodiment 4 will hereinafter be described. The description of parts common to any one of Embodiments 1 to 3 may be omitted.

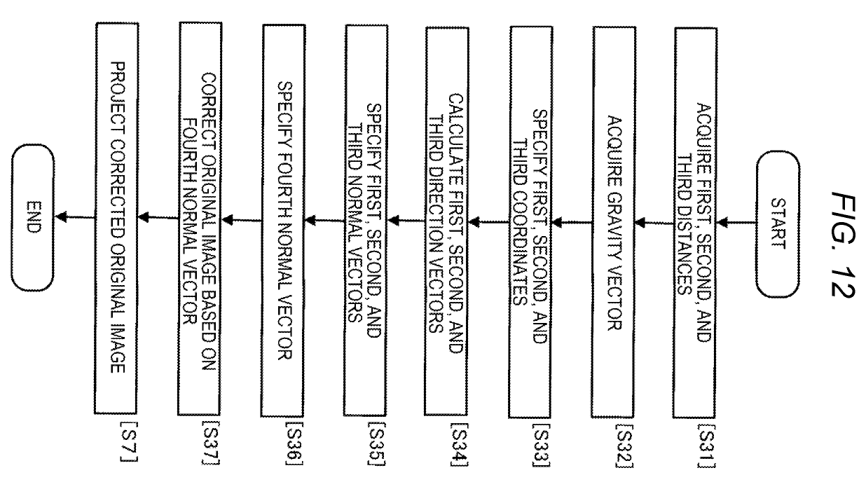

FIG. 12 is a flowchart showing an operation example of a projection apparatus 10 according to Embodiment 4. This flowchart corresponds to the flowchart of FIG. 4 in Embodiment 1.

In step S31, the processor 12 acquires a first distance, a second distance, and a third distance based on the output from the distance sensor 14.

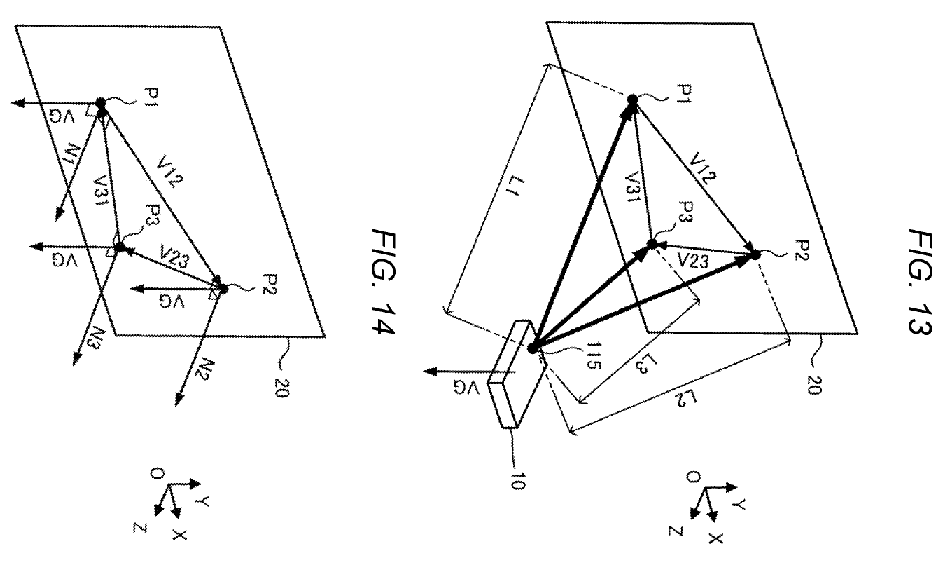

The details of step S31 will be described with reference to FIG. 13. The first distance L1 and the second distance L2 are acquired in the same manner as in Embodiment 1. The third distance L3 is a distance from the projection lens 115 to a point P3 on the screen 20. The point P3 indicates a third position. The third position is a position different from the first position and the second position. The third position is not on a straight line passing through the first position and the second position.

Then, in step S32, the processor 12 acquires the gravity vector VG in the first three-dimensional coordinate system based on the output from the acceleration sensor 15.

Then, in step S33, the processor 12 specifies first coordinates, second coordinates, and third coordinates based on the first distance L1, the second distance L2, and the third distance L3. In particular, the third coordinates are specified based on the third distance L3. The third coordinates are coordinates of the point P3 in the first three-dimensional coordinate system.

Then, in step S34, the processor 12 specifies a direction vector V12, a direction vector V23, and a direction vector V31. The direction vector V12 is a first direction vector. The direction vector V23 is a second direction vector. The direction vector V31 is a third direction vector.

The direction vector V12 is a direction vector having the coordinates of the point P1 and the coordinates of the point P2 at both ends. The direction vector V23 is a direction vector having the coordinates of the point P2 and the coordinates of the point P3 at both ends. The direction vector V31 is a direction vector having the coordinates of the point P3 and the coordinates of the point P1 at both ends.

In the example of FIG. 13, the point P1 is the initial point of the direction vector V12, and the point P2 is the terminal point of the direction vector V12. In the example of FIG. 13, the point P2 is the initial point of the direction vector V23, and the point P3 is the terminal point of the direction vector V23. In the example of FIG. 13, the point P3 is the initial point of the direction vector V31, and the point P1 is the terminal point of the direction vector V31. The initial point and the terminal point of each direction vector may be switched.

Then, in step S35, the processor 12 specifies three normal vectors.

The details of step S35 will be described with reference to FIG. 14. A first normal vector N1 is specified based on the direction vector V12 and the gravity vector VG. A second normal vector N2 is specified based on the direction vector V23 and the gravity vector VG. A third normal vector N3 is specified based on the direction vector V31 and the gravity vector VG.

The first normal vector N1, the second normal vector N2, and the third normal vector N3 are all normal vectors of a plane related to the screen 20. Ideally, all of the directions of these normal vectors are the same. However, when the screen 20 is not a perfect flat surface, these normal vectors may be normal vectors of different planes related to the screen 20. When an error is contained in the measurement of the distance, the directions of these normal vectors may not coincide with each other.

Here, similarly to Embodiment 1, the direction vector V12 is specified based on the coordinates of the point P1 and the coordinates of the point P2 in step S34. Therefore, in step S35, the first normal vector N1 is specified based on the coordinates of the point P1, the coordinates of the point P2, and the gravity vector VG. Similarly, the second normal vector N2 is specified based on the coordinates of the point P2, the coordinates of the point P3, and the gravity vector VG. Similarly, the third normal vector N3 is specified based on the coordinates of the point P3, the coordinates of the point P1, and the gravity vector VG.

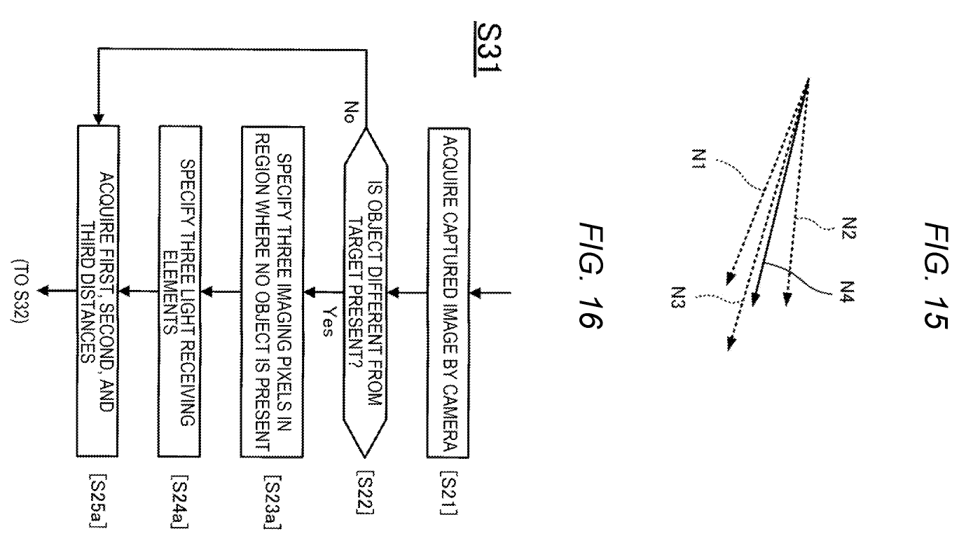

Then, in step S36, the processor 12 specifies a fourth normal vector N4 based on the first normal vector N1, the second normal vector N2, and the third normal vector N3. FIG. 15 illustrates this processing. For example, the fourth normal vector N4 is calculated as an average of the first normal vector N1, the second normal vector N2, and the third normal vector N3.

In this way, the fourth normal vector N4 of the plane related to the screen 20 is specified. The processor 12 controls the projection apparatus 10 based on the specified fourth normal vector N4.

As an example of the control of the projection apparatus 10 based on the fourth normal vector N4, steps S37 and S38 can be executed. Step S37 may be executed in the same manner as step S6 of Embodiment 1. However, in the present embodiment, in step S37, the fourth normal vector N4 is used instead of the first normal vector N1. In this way, the original image is corrected.

Step S38 may be executed in the same manner as step S7 of Embodiment 1. Thus, the projection image 30 is projected on the screen 20 via the projection lens 115.

According to Embodiment 4 described above, since the final normal vector is specified based on the three normal vectors, the calculation accuracy of the final normal vector is improved.

In Embodiment 4, the three normal vectors are specified based on the three points. As a modification, four or more normal vectors may be specified based on four or more points. Thus, the calculation accuracy of the final normal vector is further improved.

### Embodiment 5

Embodiment 5 is an embodiment formed by combining Embodiment 3 and Embodiment 4. Embodiment 5 will hereinafter be described. The description of parts common to Embodiments 3 or 4 may be omitted.

The distance sensor 14 according to Embodiment 5 includes four or more light receiving elements 142. In the example of FIG. 7, four light receiving elements 142 are illustrated. The four or more light receiving elements 142 respectively receive reflected lights LR of the incident light LI reflected from four or more positions on the screen 20.

The camera 16 according to Embodiment 5 includes four or more imaging pixels. In the example of FIG. 11, the camera 16 includes at least eight imaging pixels. In Embodiment 5, it is assumed that the first region contains three or more imaging pixels. In the example of FIG. 11, the first region R1 includes five imaging pixels.

An operation example of the projection apparatus 10 according to Embodiment 5 is shown by changing the processing of step S31 in the flowchart of FIG. 12 according to Embodiment 4 to the processing illustrated in FIG. 16.

FIG. 16 is a flowchart showing a processing example of step S31 in Embodiment 5. In the present embodiment, step S31 includes the steps shown in FIG. 16. Steps S21 and S22 may be executed in the same manner as those shown in FIG. 10 according to Embodiment 3. For example, in step S21, the processor 12 acquires a captured image captured by the camera 16. Then, in step S22, the processor 12 determines whether an object different from the screen 20 is present.

When it is determined in step S22 that an object is present, the processor 12 executes steps S23a and S24a. In step S23a, the processor 12 specifies three imaging pixels from among the three or more imaging pixels contained in the first region R1 in which no object is present. In the example of FIG. 11, three imaging pixels are specified from among the five imaging pixels C11, C12, C13, C14, and C18 forming the first region R1. Here, the criterion for specifying three imaging pixels when four or more imaging pixels are contained in the first region R1 as illustrated in FIG. 11 can be optionally designed. The specified three imaging pixels are referred to as a first imaging pixel, a second imaging pixel, and a third imaging pixel.

After step S23a, in step S24a, the processor 12 specifies the three light receiving elements. In particular, the processor 12 specifies the three light receiving elements based on the correspondence relationship between the four or more imaging pixels of the camera 16 and the four or more light receiving elements. For example, the first light receiving element corresponding to the first imaging pixel, the second light receiving element corresponding to the second imaging pixel, and the third light receiving element corresponding to the third imaging pixel are specified.

After step S24a, in step S25a, the processor 12 acquires a first distance L1, a second distance L2, and a third distance L3. The first distance L1 is a distance acquired based on the output from the first light receiving element. The second distance L2 is a distance acquired based on the output from the second light receiving element. The third distance L3 is a distance acquired based on the output from the third light receiving element.

When it is determined in step S22 described above that no object is present, the processor 12 advances the processing to step S25a. In this case, the first distance L1, the second distance L2, and the third distance L3 can be acquired based on output from any three light receiving elements.

The processing after step S25a may be executed in the same manner as step S32 and subsequent steps in Embodiment 4.

According to Embodiment 5 described above, both the effects of Embodiment 3 and the effects of Embodiment 4 may be obtained. For example, since the distances in the region where no object is present can be used, the distances to the screen 20 are measured more accurately, and since the final normal vector is specified based on the three normal vectors, the calculation accuracy of the final normal vector is improved.

### Other Embodiments

In the embodiments described above, the projection apparatus 10 includes the sensors. For example, the projection apparatus 10 includes the distance sensor 14 and the acceleration sensor 15. In Embodiments 3 and 5, the projection apparatus 10 includes the camera 16. As a modification, at least one of these sensors may be provided outside the projection apparatus 10. In such a case, the processor 12 of the projection apparatus 10 may receive the output from the sensor provided outside. In such a case, the projection apparatus 10 and at least one sensor provided outside can form a projection system.

In each of the embodiments described above, the physical component unit of each sensor can be optionally designed. For example, a distance sensor that measures the distance to the point P1 and a distance sensor that measures the distance to the point P2 may be separately provided. For example, one distance sensor may include a plurality of light receivers. In this case, for example, each of the plurality of light receivers may include one light receiving element, or each of the plurality of light receivers may include a plurality of light receiving elements.

In the embodiments described above, when the camera 16 is provided, the distance sensor 14 may be omitted. In this case, the first distance L1, the second distance L2, and the like may be measured by a triangulation method based on the image captured by the camera 16. In this case, the camera 16 may be the first sensor.

A specific method of implementing the triangulation method can be optionally designed based on a known technique or the like, and an example will be described below. The projection apparatus 10 projects an image for measurement on the screen 20. The image for measurement is an image including a plurality of markers. Each of the markers indicates a position of each of a point P1, a point P2, and the like to be measured. The direction of each point viewed from the projection lens 115 can be specified based on the pixel position of the marker in the projected original image. Furthermore, the direction of each point viewed from the camera 16 can be specified based on the pixel position of the marker in the image captured by the camera 16. Moreover, the distance to each point can be specified based on the position of the projection lens 115, the direction of each point viewed from the projection lens 115, the position of the camera 16, and the direction of each point viewed from the camera 16.

In each of the embodiments described above, the order of the processing shown in each flowchart can be appropriately changed by those skilled in the art. For example, in FIG. 4, step S2 can be executed at any time point before step S5. Alternatively, step S2 may be executed before the processing of FIG. 4 is started.

When a plurality of pieces of processing are executed in one step, the order of the execution of the processing may be optionally designed. For example, in step S33 of FIG. 12, the order of the execution of the processing of specifying the first coordinates, the processing of specifying the second coordinates, and the processing of specifying the third coordinates is not limited.

### Appendices

The summary of the present disclosure is appended below.

### Appendix 1

A control method for a projection apparatus that projects an image onto a target via a projection lens, includes, by one or more processors, acquiring a first distance from the projection lens to a first position on the target and a second distance from the projection lens to a second position on the target based on output from a first sensor, acquiring a gravity vector in a first three-dimensional coordinate system based on output from a second sensor, specifying first coordinates of the first position in the first three-dimensional coordinate system based on the first distance, specifying second coordinates of the second position in the first three-dimensional coordinate system based on the second distance, and specifying a first normal vector of a plane related to the target in the first three-dimensional coordinate system based on the first coordinates, the second coordinates, and the gravity vector.

According to the control method of Appendix 1, it is possible to more easily appropriately specify the first normal vector N1 of the screen 20 by using the gravity vector VG.

### Appendix 2

In the control method according to Appendix 1, the first sensor includes at least one light source that emits an incident light incident on the target, and three or more light receiving elements that respectively receive reflected lights of the incident light reflected from three or more positions on the target, the control method includes, by the one or more processors, acquiring three or more intensity values each indicating intensity of the reflected light and corresponding to the three or more light receiving elements on a one-to-one basis based on output from each of the three or more light receiving elements, and specifying a first light receiving element and a second light receiving element corresponding to two intensity values that satisfy a first criterion among the three or more intensity values, the first distance is a distance acquired based on output from the first light receiving element, and the second distance is a distance acquired based on output from the second light receiving element.

According to the control method of Appendix 2, since two light receiving elements exhibiting particularly large intensity values are selected among the three or more light receiving elements, it is possible to suppress reduction in the measurement accuracy of the first distance L1 and the second distance L2.

### Appendix 3

In the control method according to Appendix 1 or 2, the first sensor includes at least one light source that emits an incident light incident on the target, and three or more light receiving elements that respectively receive reflected lights of the incident light reflected from three or more positions on the target, the control method includes, by the one or more processors, determining whether an object different from the target is present in a space from the projection lens to the target based on a captured image captured by a third sensor including three or more imaging pixels, when determining that the object is present in the space, specifying a first imaging pixel and a second imaging pixel from among a plurality of imaging pixels contained in a first region that is a region where the object is not present in the captured image, and specifying a first light receiving element corresponding to the first imaging pixel and a second light receiving element corresponding to the second imaging pixel based on a correspondence relationship between the three or more imaging pixels and the three or more light receiving elements, the first distance is a distance acquired based on output from the first light receiving element, and the second distance is a distance acquired based on output from the second light receiving element.

According to the control method of Appendix 3, since the distances in the region where no object is present can be used as the first distance L1 and the second distance L2, the distances to the screen 20 are measured more accurately.

### Appendix 4

In the control method according to any one of Appendices 1 to 3, the control method further includes, by the one or more processors, acquiring a third distance from the projection lens to a third position on the target based on output from the first sensor, specifying third coordinates of the third position in the first three-dimensional coordinate system based on the third distance, specifying a second normal vector of a plane related to the target in the first three-dimensional coordinate system based on the second coordinates, the third coordinates, and the gravity vector, specifying a third normal vector of a plane related to the target in the first three-dimensional coordinate system based on the third coordinates, the first coordinates, and the gravity vector, and specifying a fourth normal vector of a plane related to the target based on the first normal vector, the second normal vector, and the third normal vector.

According to the control method of Appendix 4, since the final normal vector is specified based on the three normal vectors, the calculation accuracy of the final normal vector is improved.

### Appendix 5

In the control method according to Appendix 3 or 4, the first sensor includes four or more light receiving elements that respectively receive reflected lights of the incident light reflected from four or more positions on the target, and the third sensor includes four or more imaging pixels, the control method further includes, by the one or more processors, when determining that the object is present in the space, specifying a third imaging pixel from among three or more imaging pixels contained in the first region, specifying a third light receiving element corresponding to the third imaging pixel based on a correspondence relationship between the four or more imaging pixels and the four or more light receiving elements, acquiring a third distance from the projection lens to a third position on the target based on output from the third light receiving element, specifying third coordinates of the third position in the first three-dimensional coordinate system based on the third distance, specifying a second normal vector of a plane related to the target in the first three-dimensional coordinate system based on the second coordinates, the third coordinates, and the gravity vector, specifying a third normal vector of a plane related to the target in the first three-dimensional coordinate system based on the third coordinates, the first coordinates, and the gravity vector, and specifying a fourth normal vector of a plane related to the target based on the first normal vector, the second normal vector, and the third normal vector.

According to the control method of Appendix 5, since the distances in the region where no object is present can be used, the distances to the screen 20 are measured more accurately, and since the final normal vector is specified based on the three normal vectors, the calculation accuracy of the final normal vector is improved.

### Appendix 6

In the control method according to any one of Appendices 1 to 5, the control method further includes specifying a direction vector having the first coordinates and the second coordinates at both ends by the one or more processors, wherein the first normal vector is specified based on the direction vector and the gravity vector.

According to the control method of Appendix 6, since the first normal vector N1 is calculated using the direction vector V12, the amount of calculation by the processor 12 is reduced.

### Appendix 7

A projection system that projects an image onto a target via a projection lens, includes acquiring a first distance from the projection lens to a first position on the target and a second distance from the projection lens to a second position on the target based on output from a first sensor, acquiring a gravity vector in a first three-dimensional coordinate system based on output from a second sensor, specifying first coordinates of the first position in the first three-dimensional coordinate system based on the first distance, specifying second coordinates of the second position in the first three-dimensional coordinate system based on the second distance, and specifying a first normal vector of a plane related to the target in the first three-dimensional coordinate system based on the first coordinates, the second coordinates, and the gravity vector.

According to the projection system of Appendix 7, it is possible to more easily appropriately specify the first normal vector N1 of the screen 20 by using the gravity vector VG.

### Appendix 8

A non-transitory computer-readable storage medium storing a program for controlling a projection apparatus that projects an image onto a target via a projection lens, the program causes one or more processors to execute acquiring a first distance from the projection lens to a first position on the target and a second distance from the projection lens to a second position on the target based on output from a first sensor, acquiring a gravity vector in a first three-dimensional coordinate system based on output from a second sensor, specifying first coordinates of the first position in the first three-dimensional coordinate system based on the first distance, specifying second coordinates of the second position in the first three-dimensional coordinate system based on the second distance, and specifying a first normal vector of a plane related to the target in the first three-dimensional coordinate system based on the first coordinates, the second coordinates, and the gravity vector.

According to the program of Appendix 8, it is possible to more easily appropriately specify the first normal vector N1 of the screen 20 by using the gravity vector VG.

What is claimed is:

1. A control method for a projection apparatus that projects an image onto a target via a projection lens, the control method comprising:
by one or more processors,
acquiring a first distance from the projection lens to a first position on the target and a second distance from the projection lens to a second position on the target based on output from a first sensor;
acquiring a gravity vector in a first three-dimensional coordinate system based on output from a second sensor;
specifying first coordinates of the first position in the first three-dimensional coordinate system based on the first distance;
specifying second coordinates of the second position in the first three-dimensional coordinate system based on the second distance; and
specifying a first normal vector of a plane related to the target in the first three-dimensional coordinate system based on the first coordinates, the second coordinates, and the gravity vector.

2. The control method according to claim 1,
the first sensor including
at least one light source that emits an incident light incident on the target, and
three or more light receiving elements that respectively receive reflected lights of the incident light reflected from three or more positions on the target,
the control method further comprising:
by the one or more processors,
acquiring three or more intensity values each indicating intensity of the reflected lights and corresponding to the three or more light receiving elements on a one-to-one basis based on output from each of the three or more light receiving elements; and
specifying a first light receiving element and a second light receiving element corresponding to two intensity values that satisfy a first criterion among the three or more intensity values, wherein
the first distance is a distance acquired based on output from the first light receiving element, and
the second distance is a distance acquired based on output from the second light receiving element.

3. The control method according to claim 1,
the first sensor including
at least one light source that emits an incident light incident on the target, and
three or more light receiving elements that respectively receive reflected lights of the incident light reflected from three or more positions on the target,
the control method further comprising:
by the one or more processors,
determining whether an object different from the target is present in a space from the projection lens to the target based on a captured image captured by a third sensor including three or more imaging pixels;
when determining that the object is present in the space,
specifying a first imaging pixel and a second imaging pixel from among a plurality of imaging pixels contained in a first region that is a region where the object is not present in the captured image; and
specifying a first light receiving element corresponding to the first imaging pixel and a second light receiving element corresponding to the second imaging pixel based on a correspondence relationship between the three or more imaging pixels and the three or more light receiving elements, wherein
the first distance is a distance acquired based on output from the first light receiving element, and
the second distance is a distance acquired based on output from the second light receiving element.

4. The control method according to claim 1, further comprising:
by the one or more processors,
acquiring a third distance from the projection lens to a third position on the target based on output from the first sensor;
specifying third coordinates of the third position in the first three-dimensional coordinate system based on the third distance;
specifying a second normal vector of a plane related to the target in the first three-dimensional coordinate system based on the second coordinates, the third coordinates, and the gravity vector;
specifying a third normal vector of a plane related to the target in the first three-dimensional coordinate system based on the third coordinates, the first coordinates, and the gravity vector; and
specifying a fourth normal vector of a plane related to the target based on the first normal vector, the second normal vector, and the third normal vector.

5. The control method according to claim 3,
the first sensor including four or more light receiving elements that respectively receive reflected lights of the incident light reflected from four or more positions on the target,
the third sensor including four or more imaging pixels,
the control method further comprising:
by the one or more processors,
when determining that the object is present in the space,
specifying a third imaging pixel from among three or more imaging pixels contained in the first region,
specifying a third light receiving element corresponding to the third imaging pixel based on a correspondence relationship between the four or more imaging pixels and the four or more light receiving elements,
acquiring a third distance from the projection lens to a third position on the target based on output from the third light receiving element,
specifying third coordinates of the third position in the first three-dimensional coordinate system based on the third distance,
specifying a second normal vector of a plane related to the target in the first three-dimensional coordinate system based on the second coordinates, the third coordinates, and the gravity vector,
specifying a third normal vector of a plane related to the target in the first three-dimensional coordinate system based on the third coordinates, the first coordinates, and the gravity vector, and
specifying a fourth normal vector of a plane related to the target based on the first normal vector, the second normal vector, and the third normal vector.

6. The control method according to claim 1, further comprising specifying a direction vector having the first coordinates and the second coordinates at both ends by the one or more processors, wherein
the first normal vector is specified based on the direction vector and the gravity vector.

7. A projection system that projects an image onto a target via a projection lens, the projection system comprising:
acquiring a first distance from the projection lens to a first position on the target and a second distance from the projection lens to a second position on the target based on output from a first sensor;
acquiring a gravity vector in a first three-dimensional coordinate system based on output from a second sensor;
specifying first coordinates of the first position in the first three-dimensional coordinate system based on the first distance;
specifying second coordinates of the second position in the first three-dimensional coordinate system based on the second distance; and
specifying a first normal vector of a plane related to the target in the first three-dimensional coordinate system based on the first coordinates, the second coordinates, and the gravity vector.

8. A non-transitory computer-readable storage medium storing a program for controlling a projection apparatus that projects an image onto a target via a projection lens, the program causing one or more processors to execute:
acquiring a first distance from the projection lens to a first position on the target and a second distance from the projection lens to a second position on the target based on output from a first sensor;
acquiring a gravity vector in a first three-dimensional coordinate system based on output from a second sensor;
specifying first coordinates of the first position in the first three-dimensional coordinate system based on the first distance;
specifying second coordinates of the second position in the first three-dimensional coordinate system based on the second distance; and
specifying a first normal vector of a plane related to the target in the first three-dimensional coordinate system based on the first coordinates, the second coordinates, and the gravity vector.
